(19) United States
(12) Patent Application Publication
(10) Pub. No.: US 2015/0005074 A1
(43) Pub. Date: Jan. 1, 2015

(54) SYSTEM AND METHOD FOR REAL TIME INTERACTIVE FAN BASED COMPETITION

(71) Applicant: Kevin Moshayedi, Newport Beach, CA (US)

(72) Inventor: Kevin Moshayedi, Newport Beach, CA (US)

(21) Appl. No.: 13/932,938

(22) Filed: Jul. 1, 2013

(51) Int. Cl. A63F 13/30

(52) U.S. Cl. CPC A63F 13/12
USPC 463/42

(57) ABSTRACT

A system and method of participating in a live competition on a network as part of a fan based team. In embodiments of the invention fans of one collegiate or professional sport team compete against the fans of another sport team at the same time that the sport teams are competing.

### CROSS REFERENCE TO RELATED APPLICATIONS

This non-provisional United States (U.S.) patent application claims the benefit of U.S. Provisional Patent Application No. 61/666,744 entitled, “SYSTEM AND METHOD FOR REAL TIME INTERACTIVE FAN BASED COMPETITION”, filed on Jun. 29, 2012 by inventor Kevin Moshayedi, which is incorporated herein by reference.

### TECHNICAL FIELD OF THE INVENTION

This invention relates generally to interactive games, and in particular, to a system and method of participating in a live competition on a network as member of a fan based team.

### BACKGROUND

Fans have always sought to be more involved in the activities of their favorite team. Some wear their team's colors and logos. Others memorize the history and statistic of every user on their team's roster past and present.

With the advent of fantasy leagues, fan participation has gone on-line. In a fantasy league, participants act as team owners to draft a team that competes against other fantasy owners based on the statistics generated by the real individual players of a professional sport. Typically, statistical performances of the professional players are converted into points for the fantasy owner.

A drawback of fantasy leagues is that they encourage loyalty to individual players and their individual statistics and not to a team. Most fantasy league teams consist of players who are rivals in real life. During a game, some fantasy owners may find themselves cheering against their own real life team while trying to win the fantasy league.

Fantasy leagues also lack audience participation. Scoring relies on passively waiting for a real life statistic to be converted into fantasy points. Fantasy leagues, therefore, do not alleviate the dead time built into every game for events like time-outs, half-times, and commercial breaks.

What is needed is a game or competition that promotes undivided loyalty to a team while also allowing the fan to actively participate in the competition.

### SUMMARY OF THE INVENTION

The invention is a game or competition that enables users or players to engage in team based game play. In this application, the invention will be referred to as the game, the interactive game, or the “Game”. The interactive game may be played on a user device e.g. smart phone, tablet device, laptop computer, gaming platform, or personal computer. Preferably the user device is mobile and connected to a network. The game may be stored on a server connected to the network and accessible to each user device via the network.

In one embodiment of the invention, each “Game” preferably takes place parallel to a live professional or collegiate sporting event e.g. NFL, NBA, MLB, NHL, PGA, NASCAR, NCAA Football, NCAA basketball.

During the live professional or collegiate sporting event, users access a server via their user devices. Once accessed, users have the option of creating an on-line profile or playing as a guest. The user then selects which live sporting event they would like to participate in. A user then selects which fan squad he or she would like to play for. A fan squad, as used in this document, is the pool of users who play for either one of the teams participating in the live sporting event.

### Fan Squads

Fans of professional and collegiate sports have no physical impact on the outcome of their team's performance. However, professional and collegiate teams have large fan bases with a desire to represent their team in competition.

An embodiment of this invention enables such competition by allowing users to represent a professional or collegiate team via a competitive interactive game which is played parallel to the live professional or collegiate sporting event. One embodiment of the invention involves a question/answer format but the invention is not limited to such game play and many other game styles may be used. A win for each respective game is awarded to the Fan Squad which has accumulated the most points at the end of the game.

For example, a user selects a professional sports game, in this example the National Football League. The contestants in the live professional game are the Green Bay Packers® vs. the Dallas Cowboys®. The professional game starts at 7:30 pm Eastern Standard Time.

Users log into game server via their user device and can begin playing live for either team's “Fan Squad” during the duration of the Packers® vs. Cowboys® game. In the interactive game, users select between: a) Green Bay Packer's® Fan Squad or b) Dallas Cowboy's® Fan Squad. A Fan Squad is the group of users representing a professional or collegiate team in the interactive parallel game.

Users can play for different “Fan Squads”. “Fan Squads” consist of pools of users playing an interactive game. This interactive game plays parallel to an actual professional or collegiate game. Users playing the interactive game represent their team via their team's “Fan Squad”. In this particular example users of the interactive game can play for either a “Dallas Fan Squad” or “Green Bay Fan Squad” in the interactive game. As the interactive game begins for the “Green Bay Packer® Fan Squad” vs. “Dallas Cowboy® Fan Squad”, users answer questions.

The user's answers correlate with their “Fan Squads” overall performance in the game (points are distributed per question in the game). As the game progresses, overall points accumulate for both “Fan Squads” and at the end of the game a winner is determined between the two team's “Fan Squads”. Although a question/answer style format is referenced throughout this document, the invention is not limited only to such game play.

At the end of an interactive game, a winner is determined based on which team's “Fan Squad” scores more points in that specific interactive game. The winning “Fan Squad” for a particular interactive game receives points for their team's WIN.

Once users are logged onto the server and have selected the team which they would like to represent in the game, they can begin playing. Preferably, users can only play during the time the live sporting event is taking place. Each user represents their selected team in the game. The user's performance during the game affects the outcome of his or her Fan Squad's performance. Points are allotted based on which competing Fan Squads perform better in each period of the game. The Fan Squad which performs best over the course of the game and accumulates the most points is awarded the win for that particular game and is rewarded with points. Users may also accumulate points for their individual performance over the course of the game.

The user's collective performance is gathered by their user devices and the information is sent to the server database which aggregates and relays the actions of each game to and from the user devices via the network connection. As the season progresses user's accumulated points may be redeemable at a reward center for prizes.

Other aspects, advantages and novel features of the present disclosure will become apparent from the following detailed description of the disclosure when considered in conjunction with the accompanying drawings.

### BRIEF DESCRIPTION OF THE DRAWINGS

FIG. 1 illustrates a log-in screen of an exemplary embodiment of the invention.

FIG. 2 illustrates an account creation screen for an exemplary embodiment of the invention.

FIG. 3 illustrates a home dashboard screen of an exemplary embodiment of the invention.

FIG. 4 illustrates a sport selection screen of an exemplary embodiment of the invention.

FIG. 5 illustrates a game selection screen of an exemplary embodiment of the invention.

FIG. 6 illustrates a team selection screen of an exemplary embodiment of the invention.

FIG. 7 illustrates a status screen of an exemplary embodiment of the invention.

FIG. 8 illustrates a main game screen of an exemplary embodiment of the invention.

FIG. 9A illustrates a shopping screen of an exemplary embodiment of the invention.

FIG. 9B illustrates another shopping screen of an exemplary embodiment of the invention.

FIG. 10A illustrates a scoreboard screen of an exemplary embodiment of the invention.

FIG. 10B illustrates a detailed score screen of an exemplary embodiment of the invention.

FIG. 11 illustrates a networking screen of an exemplary embodiment of the invention.

FIG. 12 illustrates another aspect of a networking screen of an exemplary embodiment of the invention.

FIG. 13 illustrates a setting screen of an exemplary embodiment of the invention.

FIG. 14 illustrates an account screen of an exemplary embodiment of the invention.

FIG. 15 illustrates a profile screen of an exemplary embodiment of the invention.

FIG. 16 illustrates a flowchart of an overall gaming process of an exemplary embodiment of the invention.

FIG. 17 illustrates a question scoring distribution of an exemplary embodiment of the invention.

FIG. 18 illustrates a chart of a sub-database question scoring of an exemplary embodiment of the invention.

FIG. 19 illustrates a question/score display of an exemplary embodiment of the invention.

FIG. 20 is a flowchart of a question/answer data flow of an exemplary embodiment of the invention.

FIG. 21 is a flowchart of an information submission and scoring response sequence of an exemplary embodiment of the invention.

FIG. 22 is a flowchart of a user base scoring process of an exemplary embodiment of the invention.

FIG. 23 is flowchart of a question tether diagram of an exemplary embodiment of the invention.

FIG. 24 illustrates an exemplary scoreboard where the score is visually depicted by a momentum meter embodiment of the invention.

### DETAILED DESCRIPTION OF THE EXEMPLARY EMBODIMENTS

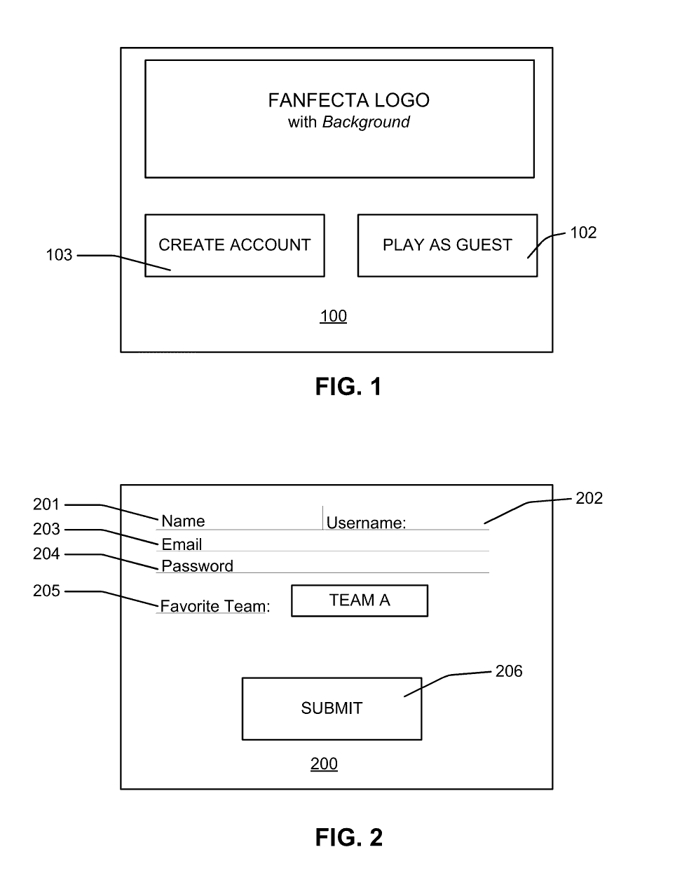

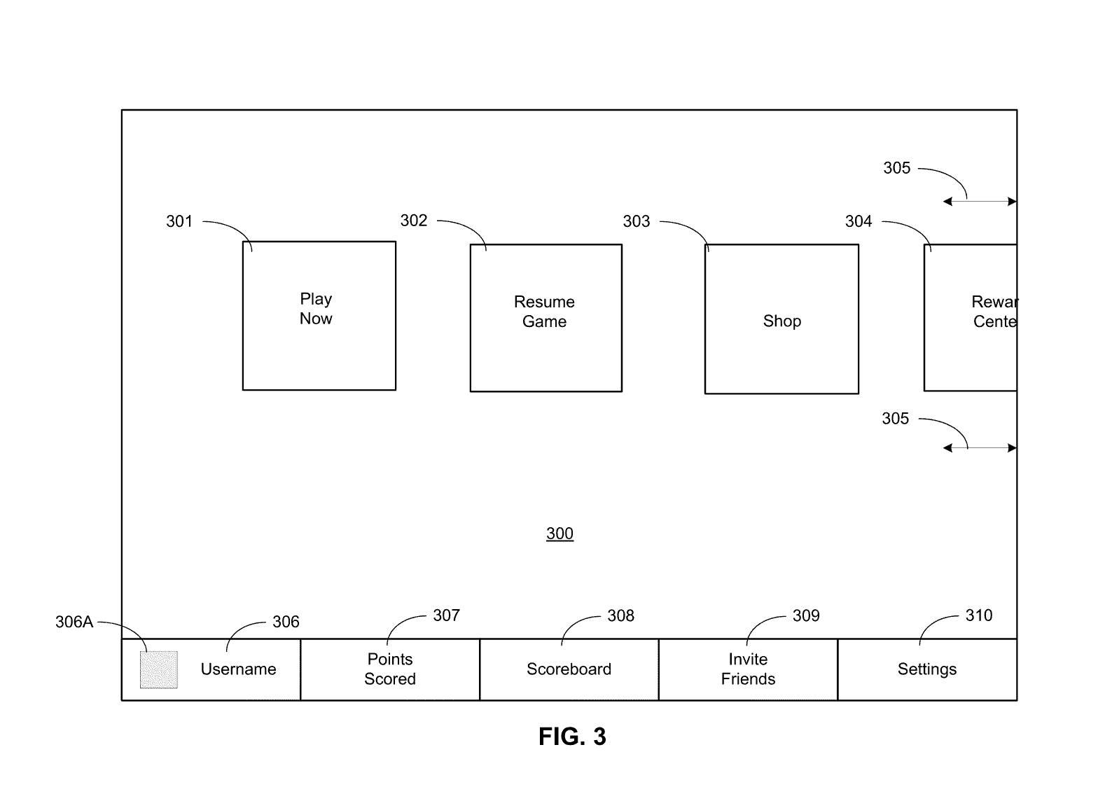

FIG. 1 illustrates an exemplary log-in screen 100 of an embodiment of the invention. This may be the first screen that displays once the game has been engaged. On this screen users select between two button options: A “Play as Guest” button 102 or a “Create an Account” button 103. If the user engages the “Play as a Guest” button 102, then he or she is linked to the Home Dashboard (FIG. 3). If the user engages the “Create an Account” button 103 then he or she is linked to (FIG. 2) where he or she will create an account. Once a user has created an account, the button 103 in FIG. 1 changes to “Account Login”.

FIG. 2 illustrates an exemplary account creation screen. Each field 201-205 of the Account Creation Screen 200 engages a typewriter/text editor function to fill in the field with the user's information. By default the typewriter is set to U.S. standard but may be changed to accommodate other languages. A user submits their name 201, username 202, email 203, password 204, and selects their favorite team 205. Once all the fields have been completed, the user may submit the information by clicking the submit button 206. The user's information is confirmed and the user is linked to the Home Dashboard (FIG. 3). The account functionality allows the game user's performance to be logged and saved throughout the life of a user's account.

FIG. 3 illustrates an exemplary home dashboard screen 300. This is the central navigation screen for the game. The middle row of buttons from left to right may include; “Play Now” 301, “Resume Game” 302, “Shop” 303, “Reward Center” 304, etc. More buttons may be displayed using a scrolling functionality 305. Each button once clicked, links to a respective page.

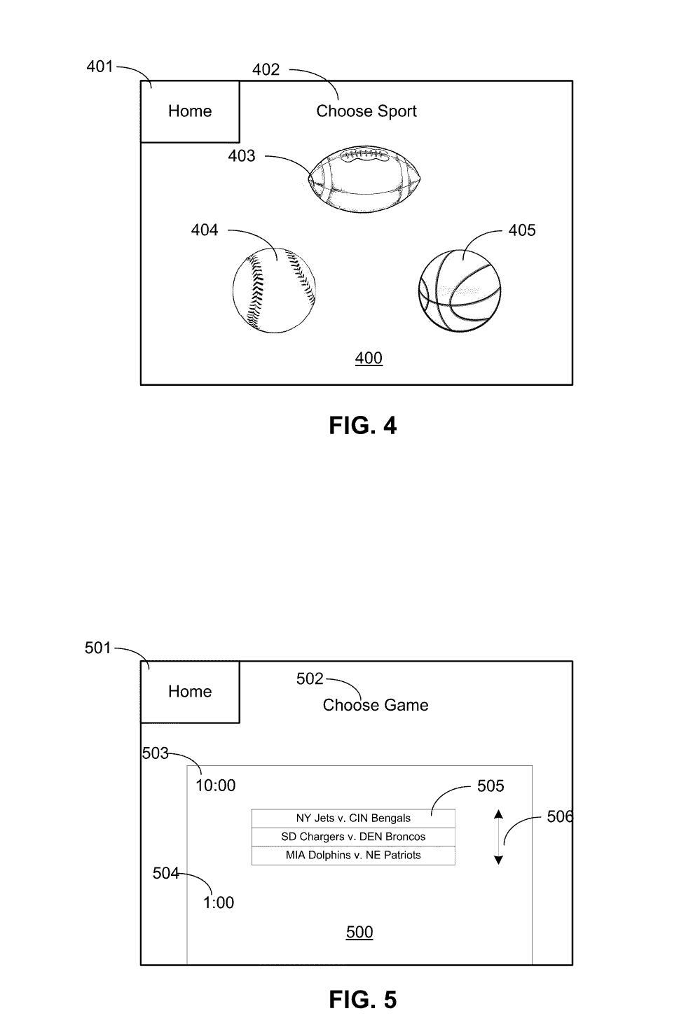

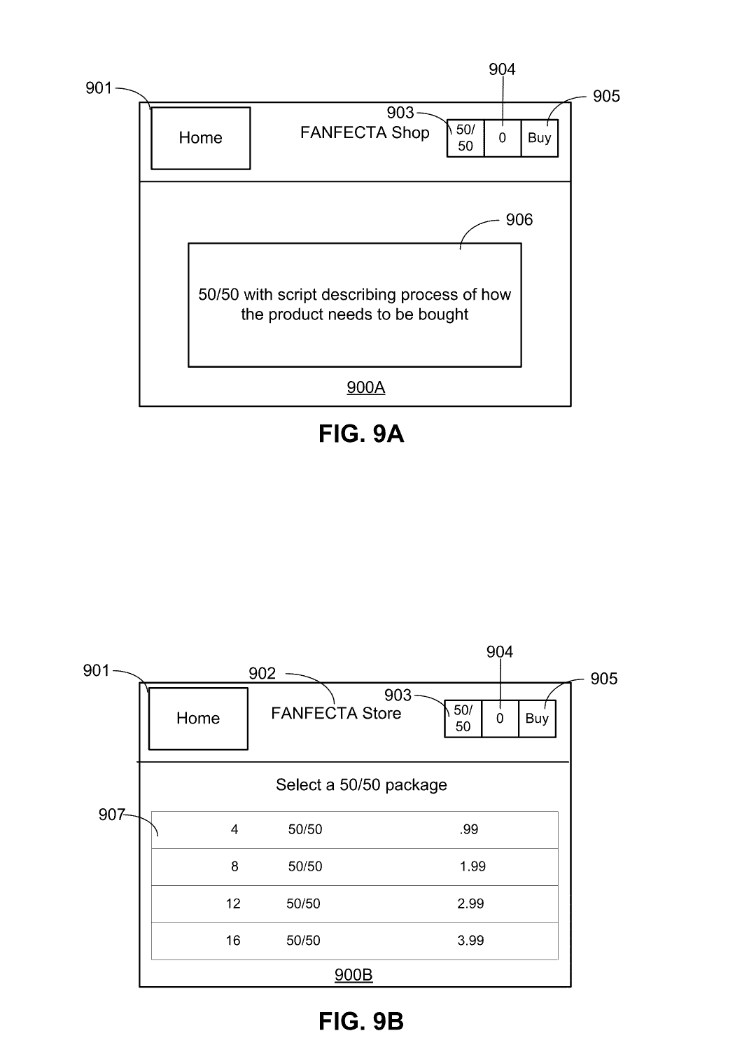

The “Play Now” button 301 moves the user to the “Choose Sport Screen” and allows them to select the game they would like to play (FIG. 4). The “Resume Game” button 302 links the user back to the “Status Screen” (FIG. 7). The “Shop” button 303 links the user to a “Shop Screen” (FIG. 9). The “Rewards Center” button 304 may engage a link which pops up an internet browser to the online rewards page which allows users to redeem their game credits for prizes.

Additional buttons may also be available such as a “Friend Feed” button which links to the “Friend Feed Screen” (FIG. 12).

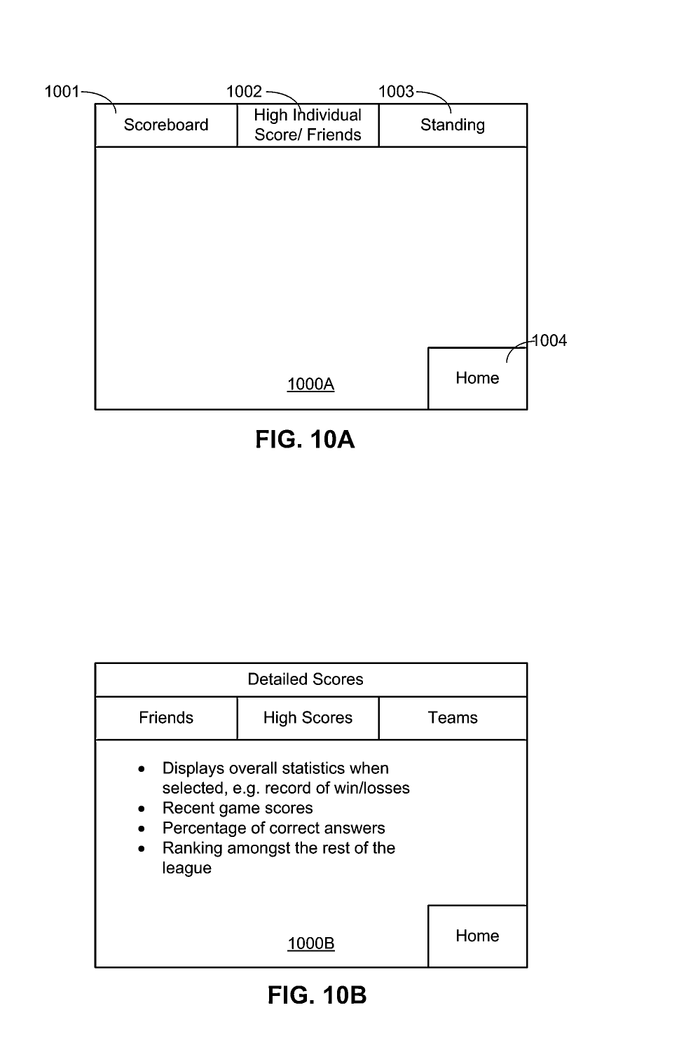

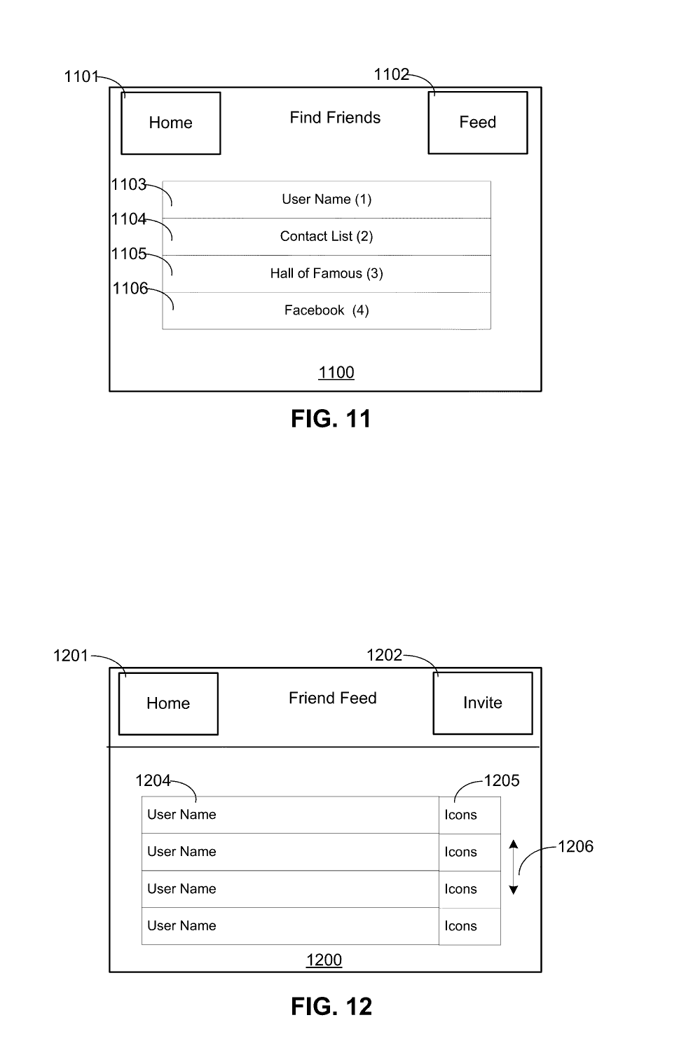

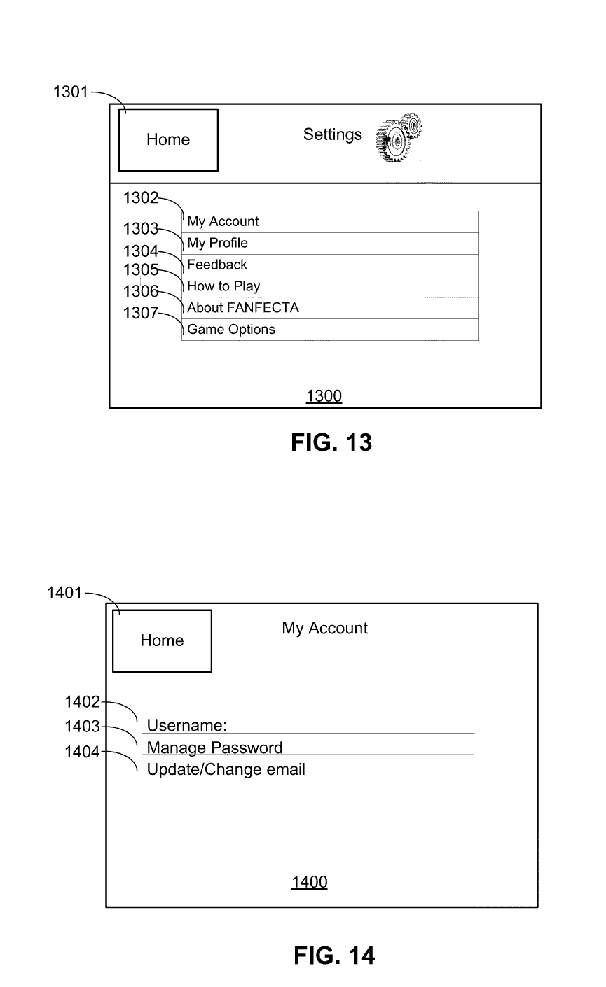

FIG. 3 also contains an exemplary lower button row 306-310 which may contain the following button: A “Username” button 306 that displays the user's name and if pressed will link to the “My Account Screen” (FIG. 2). Username button 306 may also contain a sub-window which displays a portrait of the user or user's avatar 306A. Avatar 306A may be a digital image uploaded by the user or selected from stock images during the process of creating an account. A “Points Scored” button 307 may indicate the total points a user has accumulated based on the user's account. A “Scoreboard” button 308 may link to the “Scoreboard Screen” (FIG. 10). An “Invite Friends” button 309 may link to the “Find Friend Screen” (FIG. 11). A “Settings” button 310 may link to the “Settings Screen” (FIG. 13)

FIG. 4 illustrates an exemplary sport selection screen 400. Home button 401 at the top of the screen links to the home dashboard 300. Instructions 402 may direct the user to choose a sport. This screen may allow the user to select the category of sport which the user will be engaging in a game. Each sport may be represented by an image of the ball used to play the sport. Once the user selects the respective sport by clicking on the image of an exemplary football 403, baseball 404, or basketball 405, he/she is linked to the “Choose Game Screen” (FIG. 5). Other sports e.g., soccer, hockey, NASCAR, tennis, golf may also be provided in other embodiments of the invention.

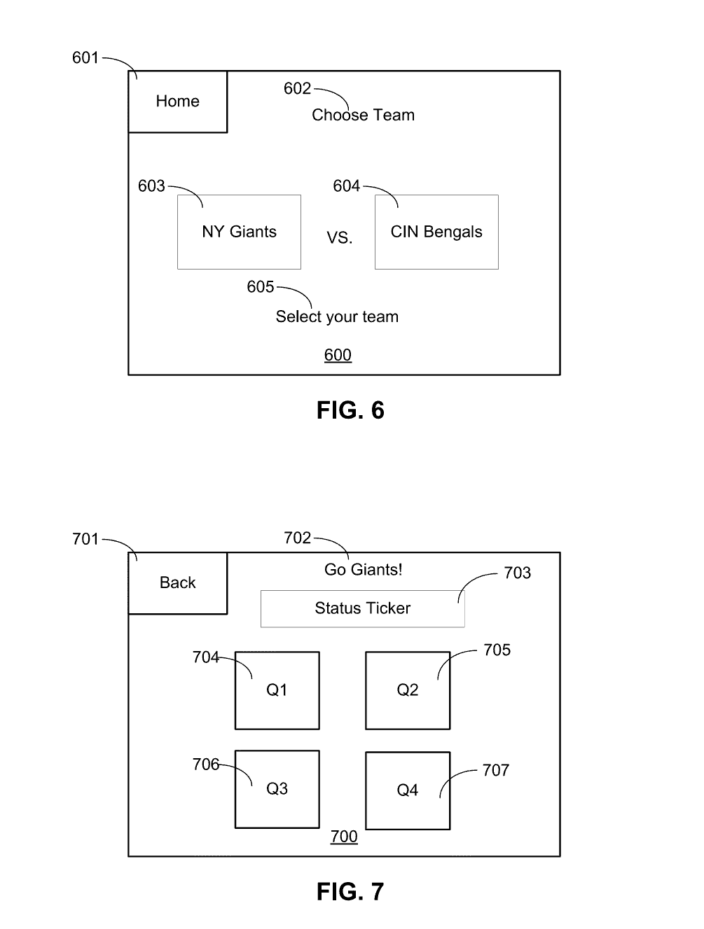

FIG. 5 illustrates an exemplary game selection screen 500. Instructions 502 may direct the user to choose a game. Users may scroll this page with the scrolling function 506 to find the live sporting game in which they would like participate. The live games 505 displayed are limited to the sport category selected in (FIG. 4). The live games 505 are organized according to their scheduled dates and times. Game times are displayed in area 503 and 504. Users select the live game 505 which they would like to play and are linked to the “Choose Team Screen” (FIG. 6). Home button 501 at the top of the screen returns the user to the home dashboard 300.

FIG. 6 illustrates an exemplary team selection screen 600. Instructions 602 may direct the user to choose a team. Once users have chosen the game in which they would like to participate (see FIG. 5), they are then able to select the team which they would like to play for, choosing between the exemplary displayed teams 603 and 604. Once a team has been selected the user is linked to the “Status Screen” (FIG. 7).

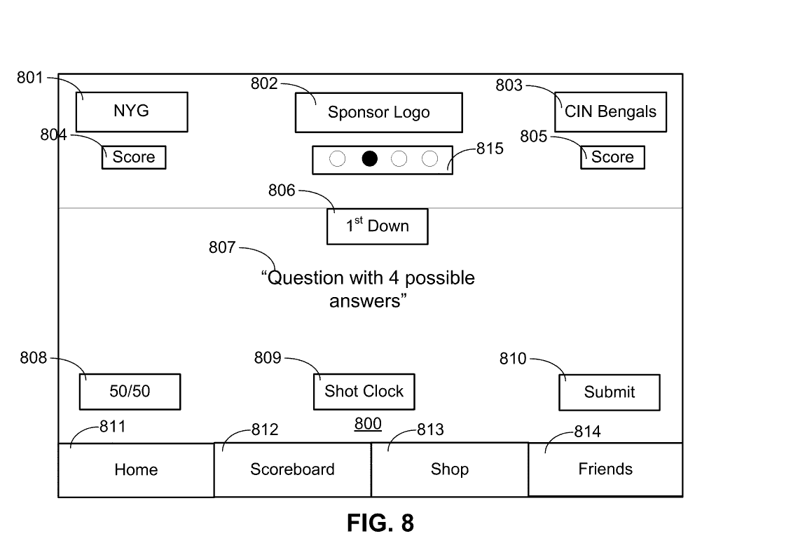

FIG. 7 illustrates an exemplary game status screen 700. Expression of encouragement and other emotives may be displayed at 702. Users in this screen are able to see what stage of the game is currently in progress for the game they desire to play. If the game has not started then a user is not able to proceed past this screen. A status ticker 703 may display the time remaining before the start of a game. However if the game is in progress the user may begin by joining the game in the quarter active at the time. To join a game in the current quarter, the user may press buttons 704-707. For example, to join a game in the second quarter, a user would press button Q2 (705). Once a quarter has been selected a user will be linked to the “Main Game Screen” (FIG. 8). Home button 701 at the top of the screen returns the user to the home dashboard 300.

FIG. 8 illustrates an exemplary Main Game Screen 800. The Main Game Screen 800 is the screen where users are able to participate in the game they have selected and begin playing for their respective team. Team buttons 801 and 803 may display the name and logo of the two teams currently playing. The team a user is playing for may be illuminated. The team buttons 801 and 803 may link to the team's homepage. A team's respective score is displayed under the team buttons at score indicator 804 and 805. Sponsor button 802 may display a logo and name of a corporate sponsor. Clicking on sponsor button 802 may open a web browser to link to the sponsor's home page. Status display 815 provides a visual indicator of the status of the game. In an exemplary embodiment, the visual indicator is separated into quarters with the second quarter illuminated. Another status indicator may be provided at 806. In the exemplary embodiment, every series has four downs. The status indicator 806 indicates that it is 1^{st} down.

A question and four possible answers are displayed at 807. Questions are displayed in random order and the answers are also displayed in random sequence. A user selects what they believe is the correct and answer and clicks the submit button 810 to submit their answer.

Questions or other forms of game play are communicated via the server database. As users answer and submit questions, their answers are relayed via internet connectivity to the server database. Once the server database receives the user's performance data, the data is submitted and routed to the respective live sporting event's sub-database for the game which the user is playing. Once that data has been relayed to the respective game's sub-database the user's performance is logged to the respective sequence of the game and the team for which they are playing. As users submit answers, the answers are relayed to the server database and a computing engine begins compiling user data and tabulating the outcome of each sequence, awarding points to each respective team based on its user's performance.

As the data is compiled and a score builds in the game, the score may be relayed back to the user device via the internet in real time. Users follow the performance of their team via the interactive game application scoreboard which displays each individual games respective score in the Main Game Screen 800 (FIG. 8) and on the Scoreboard Screen (FIG. 10). The questions continue to download into the Main Game Screen 800 as the live sporting event unfolds simultaneously. Each respective game takes place during the progress of a live professional or collegiate sporting event and finishes upon the completion of that live sporting event. Once the game finishes, a winner is determined based on the game's higher scoring team and all users on the winning team are compensated with points for their victory.

A 50/50 button may be displayed at 808. Clicking the 50/50 button allows the user to eliminate two wrong answers. To use the 50/50 button the player can pre-purchase game credits or if a user does not have credits, a pop-up screen will guide the user to purchase credits.

To keep the game challenging and exciting, a shot clock display 809 may run down to limit the time available to answer a question. Each question may have a predetermined amount of time to answer and the shot clock 809 will visually display the time remaining.

Additionally, the shot clock or play clock 809 could be used to measure the decreasing value of a question. A question's value would decrease as the time left on the play clock counts down. For example if Question 1 has an initial value of 10 points and the play clock 809 counts down from 30 seconds, then with only 10 seconds left of the 30 seconds on the play clock, the total possible points may decrease from 10 points to 3 points.

Buttons 811-814 at the bottom of the screen navigates to other areas of the game. For example button 811 links back to the home dashboard 300, 812 links to a Scoreboard screen (FIG. 10), 813 links to a Shop (FIG. 9), and 814 links to a Friends screen (FIG. 11).

FIG. 9A illustrates an exemplary shopping screen 900A. Home button 901 links back to the home dashboard. This screen allows a user to purchase in game application (Apps) and other merchandise. For example, this screen may sell 50/50 credits to aid users in answering the game questions. A 50/50 icon is displayed at 903 visually showing the user what is for sale. A counter 904 displays the number of 50/50 credits the user has remaining in his account. A buy button 905 links to a second exemplary shopping screen 900B.

FIG. 9B illustrates an exemplary shopping screen 900B. In shopping screen 900B a user may purchase packages of 50/50 credits. The quantity of credit is listed in the first column of package display 907 with the prices in the third column.

FIG. 10A illustrates an exemplary scoreboard screen 1000A. This page allows users to view the overall game scores across the network which are taking place live or have taken place in the past. Buttons 1001-1003 will display the information requested by the user. For example, clicking Scoreboard 1001 will display the score of the current game taking place. High Individual Score 1002 may display the overall FANFECTA champion high scores. Statistics of each individual champion may also be selected from this display. Standing 1003 may display the overall standing or record of each FANFECTA team. Home button 1004 may link back to the home dashboard 300.

FIG. 10B illustrates a detailed score screen 1000B. The detailed score screen 1000B may display more details about a user or teams statistics. Such information may include record of wins/losses, recent game scores, percentage of correct answers, and ranking amongst the rest of the league.

FIG. 11 illustrates an exemplary find friend screen 1100. This screen allows users to invite their friends to participate in a game. Home button 1101 navigates back to the home dashboard screen 300 and Feed button 1102 links to the Friend Feed screen (FIG. 12). Username 1103 allows a user to search for other players via their username. Contact list 1104 may allow the user to invite friends via their cellular phone contacts list, text contacts list, or email contacts list. Hall of Famous 1105 may be a section listing the famous players to play the Game. Facebook® 1106 may connect to the user's Facebook® account.

FIG. 12 illustrates an exemplary friend feed screen 1200. This screen allows users to view their friend's performances in previous games and also view which games their friends are currently playing. Home button 1201 navigate back to the home dashboard screen 300 and Invite button 1202 links back to the find friend screen 1100 (FIG. 11). The friend feed screen 1200 displays the usernames 1204 in an alphabetized listing. Icons or avatars of each user may be displayed at 1205. A scrolling function 1206 may be used to scroll the listing of users. Once the friend has been found, a page with their individual statics e.g. recent score, games played, correct answer percentage, etc., may be displayed by selecting their user name or icon.

Embodiments of the invention may include a chat function to allow users to communicate in real time with their friends. The chat functionality may also allow for group communication with friends or even communication with rival users during a game.

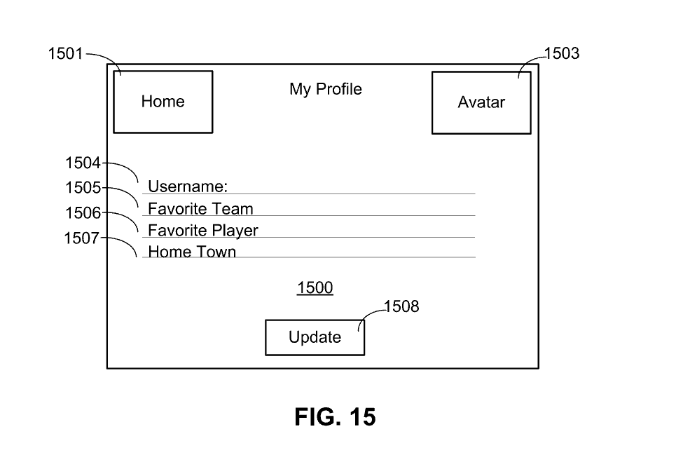

FIG. 13 illustrates an exemplary settings screen 1300. Home button 1301 navigates back to the home dashboard screen 300. A setting screen may include button links to link the user to a “My Account Screen” 1302 (FIG. 14), a “My Profile” screen 1303 (FIG. 15), a “Feedback” screen 1304 that displays a feedback page on the game's website, a “How to Play” screen 1305 that links user to a tutorial on how to play the Game, and an “About” screen 1306 which may engage a pop-out screen which tells the user information about the game. A “Game Options” screen 1307 may link players to a screen where they may customize their game's settings. Examples of customizable features may include turning on and off; sound FX, achievement progress, push notifications, game play bonus, and friend activity.

FIG. 14 illustrates an exemplary “My Account Screen” 1400 which enables users to make adjustments to their account information which they entered at the beginning of the Account Creation Screen (FIG. 2). Home button 1401 navigates back to the home dashboard screen 300. User updated information may include username change 1402, password management 1403, and email update 1404.

FIG. 15 illustrates an exemplary profile screen 1500. The “My Profile” screen 1500 allows users the ability to update information about themselves for other members of the game network to view. Updateable information may include; username 1504, favorite team 1505, favorite player 1506, and hometown 1507. An avatar 1503 may be customizable by the player. Different color helmets or uniforms may be purchased from the Shop 900A. Once players have entered any updates, they may save their updates by selecting the update button 1508.

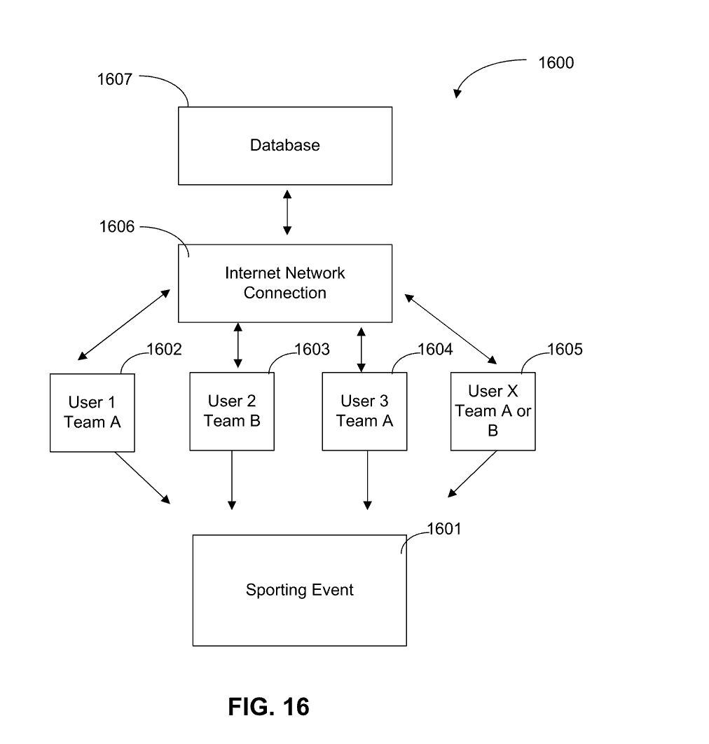

FIG. 16 shows a flow diagram of an exemplary Overall Gaming Process 1600. In box 1601 (Sporting Event), a live professional or collegiate sporting event is occurring. For example: An NFL game taking place at 8:00 pm EST between the Dallas Cowboys® and the Green Bay Packers®.

In boxes 1602-1605 (User Base), users access the interactive game via mobile phone, tablet computer, Personal computer, or laptop computer. Users play the interactive game parallel to a live professional sporting event. Each of the users playing that interactive game plays for either Team A or Team B. User X in (FIG. 2) denotes any of the users that may be playing in an interactive game and his/her ability to represent either Team A or Team B in that interactive game.

Relating to the above exemplary sporting event in (box 1601), interactive game users can begin playing the Game as soon as the live NFL game between the Dallas Cowboys® and The Green Bay Packers® begins. Users playing in the “Packers® v Cowboys® Game” can play for either team and the “Game” lasts the duration of that game's parallel live professional sporting event (in this example the duration of the Packers®/Cowboys® game).

In box 1606 (Internet), the user's mobile phone, tablet computer, personal computer, or laptop communicates with the server database via the internet. Information is relayed and received from the user's device and the database via the internet connection.

In box 1607 (Database), a database collects and distributes information for the game to a user's device.

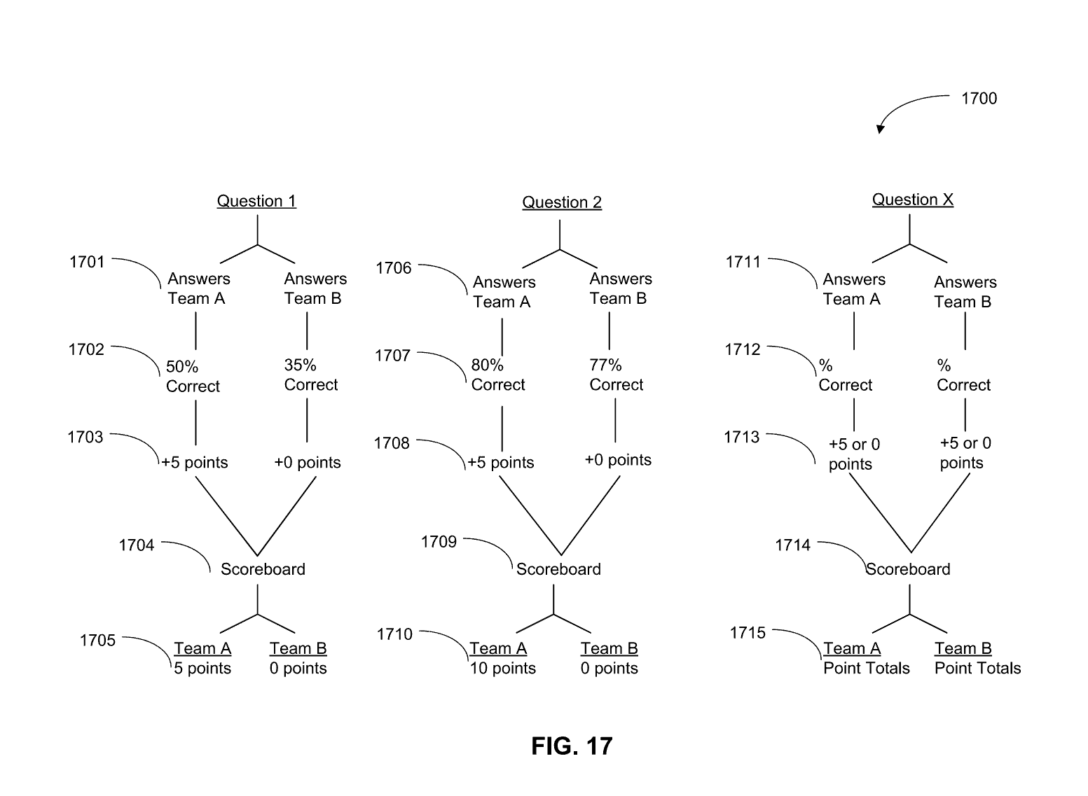

FIG. 17 illustrates an exemplary Question Scoring Distribution Chart 1700. FIG. 17 illustrates an exemplary method of determining the score as each team progresses through each question during the course of a game.

Question 1, FIG. 17
1701) Answers Team A—The pool of answers for Question 1 from Team A's User Base. Answers Team B— The pool of answers for Question 1 from Team B's User Base.
1702) Percentage Correct Team A—The percentage of users from Team A whom answered Question 1 correctly. Percentage Correct Team B—The percentage of users from Team B whom answered Question 1 correctly.
1703) Point Distribution Team A—The point distribution for each question depends on which Team's user base “percentage answered correctly” is higher among the participating teams for that specific question. In this example for Question 1, Team A performed at a “50% correct level” which was superior to Team B's “35% correct level”. As a result Team A received the total amount of points available for Question 1. Point Distribution Team B— The point distribution for each question depends on which Team's user base “percentage answered correctly” is higher among the participating teams for that specific question. In this example for Question 1, Team B underperformed at a “35% correct level” which was lower than Team A's “50% correct level”. As a result Team B did not receive any points for Question 1, because fewer Team B users (as a percentage of total Team B users) answered Question 1 correctly.
1704) Scoreboard: The area which the score is distributed to either Team A or Team B and displayed via the scoreboard. As the game progresses point totals accumulate based on a Team's performance in a game.
1705) Team A Score: Points are added based on the performance in the question and added to the Teams overall score in Game XYB. For this particular example, Team A received 5 points for its superior performance in Question 1 to that of Team B's. Thus their current total score for Game XYB is 5 points after Question 1. Team B Score—Points are added based on the performance in the question and added to the Teams overall score in Game XYB. For this particular example, Team B received 0 points for its inferior performance in Question 1 to that of Team A's. Thus their current total score for Game XYB is 0 points after Question 1.

Question 2, FIG. 17
1706) Answers Team A—The pool of answers for Question 2 from Team A's User Base. Answers Team B— the pool of answers for Question 2 from Team B's User Base.
1707) Percentage Correct Team A—The percentage of users from Team A whom answered Question 2 correctly. Percentage Correct Team B— The percentage of users from Team B whom answered Question 2 correctly.
1708) Point Distribution Team A—The point distribution for each question depends on which Team's user base “percentage answered correctly” is higher among the participating teams for that specific question. In this example for Question 2, Team A preformed at an “80% correct level” which was superior to Team B's “77% correct level”. As a result Team A received the total amount of points available for Question 2. Point Distribution Team B— The point distribution for each question depends on which Team's user base “percentage answered correctly” is higher among the participating teams for that specific question. In this example for Question 2, Team B underperformed at a “77% correct level” which was less than Team A's “80% correct level”. As a result Team B did not receive any points for Question 2, because fewer Team B users (as a percentage of total Team B users) answered Question 2 correctly.
1709) Scoreboard: The area which the score is distributed to either Team A or Team B and displayed via the scoreboard. As the game progresses point totals accumulate based on a Team's performance in a game.
1710) Team A Score: Points are added based on the performance in the question and added to the Team's overall score in Game XYB. For this particular example, Team A received 5 points for its superior performance in Question 2 to that of Team B's. Thus their current total score for Game XYB is 10 points after Question 2. Team B Score—Points are added based on the performance in the question and added to the Team's overall score in Game XYB. For this particular example, Team B received 0 points for its inferior performance in Question 2 to that of Team A's. Thus their current total score for Game XYB is 0 points after Question 2.

Question X, FIG. 17 (where X—which denotes any of the successive questions in Game XYB)
1711) Answers Team A—The pool of answers for Question X from Team A's User Base. Answers Team B— The pool of answers for Question X from Team B's User Base.
1712) Percentage Correct Team A—The percentage of users from Team A whom answered Question 1 correctly. Percentage Correct Team B— The percentage of users from Team B whom answered Question 1 correctly.
1713) Point Distribution Team A—The point distribution for the question depends on which Team's “percentage answered correctly” is higher among the participating teams for that specific question. Point Distribution Team B—The point distribution for the question depends on which Team's “percentage answered correctly” is higher among the participating teams for that specific question.
1714) Scoreboard: The area which the points scored are distributed to either Team A or Team B and displayed via the scoreboard. As the game progresses point totals accumulate based on a Team's performance in a game. (for this example GAME XYB)
1715) Team A Score: Points are added based on the performance in the question and added to the Teams Overall Score in Game XYB. Team B Score-Points are added based on the performance in the question and added to the Teams overall score in Game XYB.

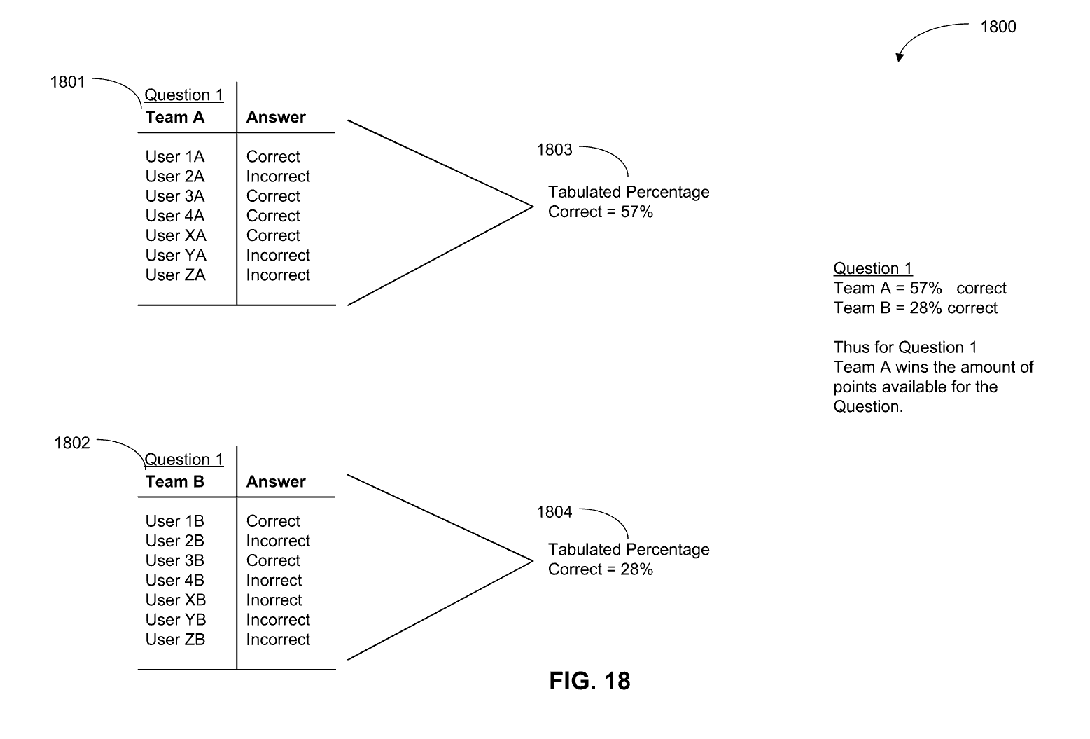

FIG. 18 is a chart of an exemplary Sub-database Question Scoring chart 1800. This sequence highlights the process once a user has submitted his/her answer for a particular question in their “Game”, their answers have been relayed to the server database, and the database has routed that user's answer(s) to their games respective sub-database.

Preferably the sub-database is a subset or relation within the main database where the information for a specific individual game is categorized. The main database may have a plurality of sub-databases where each individual game is taking place.

Once a user has submitted their answer, the subsequent process for getting a question's score takes place and the pictured figures highlight the process in which points are distributed on a question by question basis.

As users answer questions, their answers are relayed to that game's sub-database (for this example Game XYY). In block 1801 and 1802, users' answers may be organized by the team which they are playing for, either Team A or Team B and the Question for which their answer falls under. In this example block 1801 is Question 1/Team A and block 1802 is Question 1/Team B. Team A's overall user pool for Question #1 in Game XYY is listed in the left column of 1801. Each user is listed based on his/her user identification code. The user's answer status (either correct or incorrect) is listed in the right column of 1801. Team B's overall user pool for Question #1 in Game XYY is listed in the left column of 1802. Team B's user's answer status (either correct or incorrect) is listed in the right column of 1802.

As responses for that question are communicated to the server, a Team's performance is evaluated based on the percentage of correct answers submitted by either Team A (1803) or Team B (1804) for that question. The points available for that question are distributed based on which teams “answers correct” percentage for that question is greater than the others.

In this example, 57% of Team A's user base correctly answered Question 1 of Game XYY and 28% of Team B's user base correctly answered Question 1 of Game XYY. As a result of Team A's superior performance in Question 1, Team A wins Question 1 and is awarded the respective amount of points for Question 1.

Based on the number of users responding to each question, a percentage of questions answered correctly is tabulated for both teams; Team A and Team B. In this example 57% of Team A's user base correctly answered Question 1 of Game XYY and 28% of Team B's user base correctly answered Question 1 of Game XYY.

Points are distributed to either Team A or B based on which team's user base answered the question correctly. The team with a larger “percentage answered correctly” for a Questions wins the points for that question. In this example 57% of Team A's user base correctly answered Question 1 of Game XYY and 28% of Team B's user base correctly answered Question 1 of Game XYY. As a result of Team A's superior performance in Question 1, Team A wins Question 1 and is awarded the respective amount of points for Question 1.

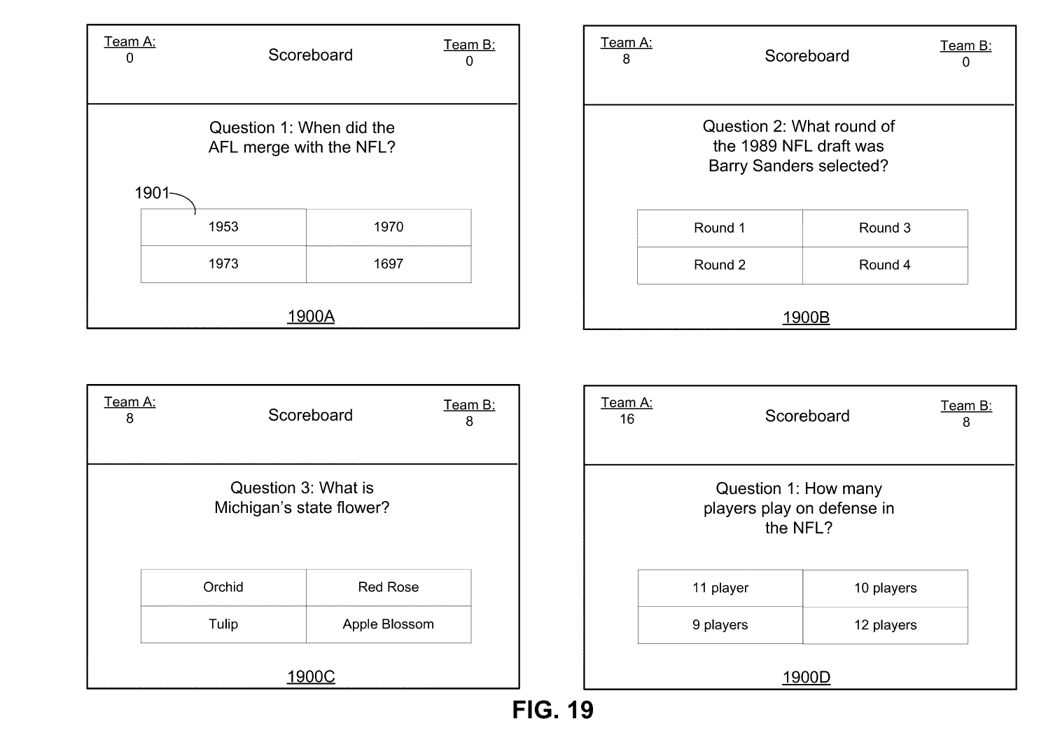

FIG. 19 illustrates a Question/Score Example. In FIG. 19 Scoreboards 1900A-1900D are illustrated. Each scoreboard asks a different question and displays four possible answers to each respective question.

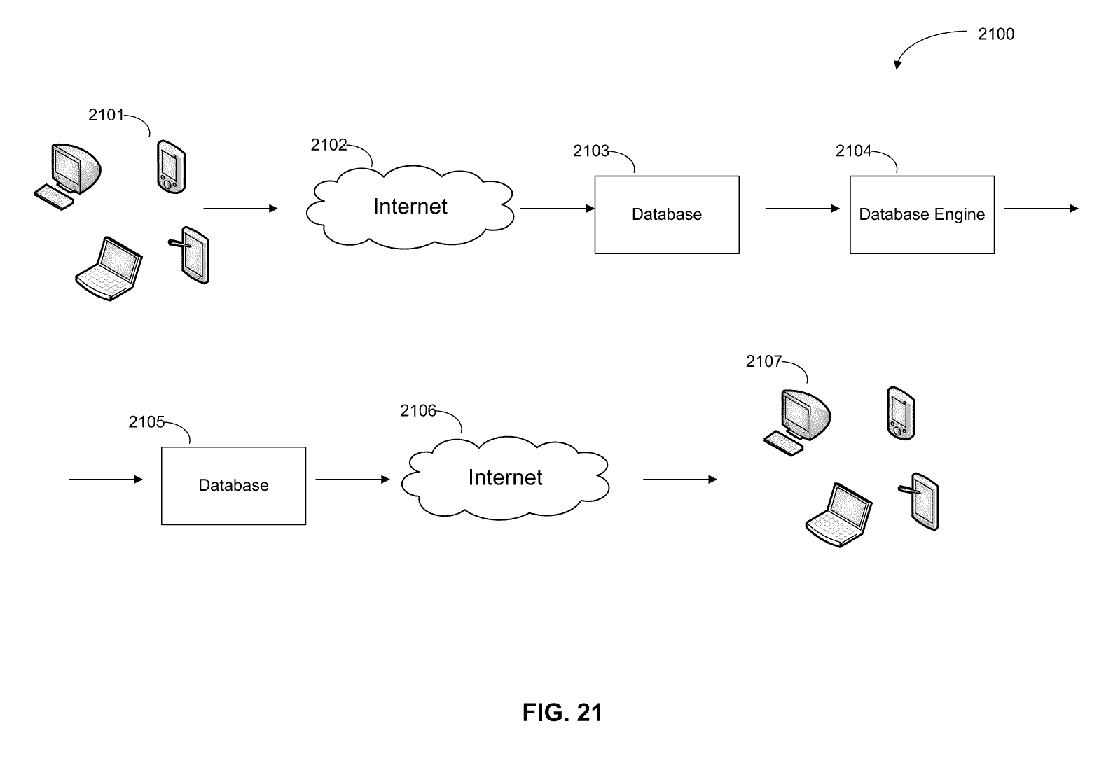

Block 1900A of FIG. 21 is a display of an exemplary interactive game's first question. Users playing the “Game” will each select one of the listed answers 1901 to that question. Once a user has submitted their answer, users can move onto the next question. The fan scoreboard 1902 shows the score between Team A and Team B as Team A (0 points) and Team B (0 points) signifying that the game has likely just begun and no answers have yet been sent in by any users representing either Team A or Team B. (Since users may join the game at any point in the games action, a user joining later in a quarter's progress may see a developed score other than Team A (0 points) and Team B (0 points) due to the game being in session, even though that user is answering his/her first question. Thus this figure only shows the score based on a user playing the game promptly in the beginning of the 1st Quarter of that “Game”.)

In block 1900B of FIG. 19 a user is provided with a second question, which he/she will submit an answer and move onto the subsequent question(s). Now that the game has begun the scoreboard will begin to adjust the score, due to the user answers relayed to the server database. In this sequence the score shows Team A with (8 points) and Team B with (0 points) which exhibits Team A's superior performance in Question 1 to that of Team B's performance.

In block 1900C of FIG. 19 a user is provided with a third question, which he/she will submit an answer and move onto the subsequent question. In this sequence the scoreboard has adjusted since the score was last displayed in (block 2) exhibiting the progress in the game and user's answer submissions. In this sequence Team A remains at 8 points and Team B has accumulated 8 points, evening the overall game score to Team A 8 points and Team B 8 points. This stage's score shows that Team B's Overall performance in Question 2 was superior to Team A's performance thus Team B was awarded the total available Points for their performance in Question 2.

In block 1900D of FIG. 19 a user is provided with a fourth question, which he/she will submit an answer and move onto the subsequent question. In this sequence the scoreboard has adjusted since the displayed score in block 3, thus exhibiting the progress in the game and user answer submissions. In this sequence Team A's point total has increased 8 points from that displayed in block 3 and Team B has not accumulated any additional points. The scoreboard in this sequence shows Team A with 16 points and Team B with 8 points exhibiting Team A's superior performance in Question 3 to that of Team B's performance in Question 3.

*Note—Questions for the game will continue to be displayed for users until the final segment of the game at which time all user's performances are scored and tabulated.

In another embodiment of the invention, a game may be scored based on an average score accrued by each team. For example, if Team A has five participants and Question 1 is worth 10 points, the points that the team would receive would be based on an average of how many points the 5 players scored averaged together. For example: If Player 1 earns 8 points, Player 2 earns 5 points, Player 3 earns 7 points, Player 4 earns 0 points, and Player 5 earns 10 points, then the total points Team A earns for their team's point score for question 1 is 6 points [(8+5+7+0+10)÷5=6]

This number would then be added to the average score for each question in that quarter and a score would be displayed for that team against the opposing teams score at the end of a quarter.

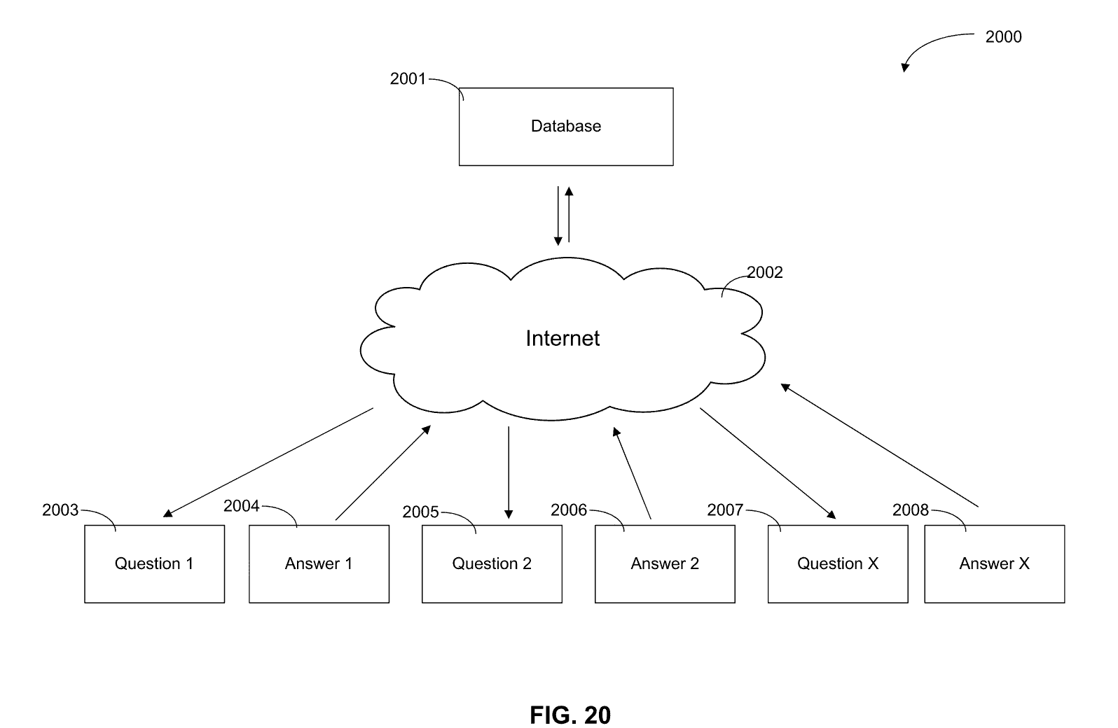

FIG. 20 is a flow diagram of an exemplary Question and Answer Data Flow 2000. In box 2001, the server database collects & distributes the information that streams to and from a user's device (mobile phone, personal computer, laptop computer, tablet computer) while connected to the gaming server.

In box 2002 the internet is shown as the preferred medium which data (e.g. game updates, questions, scoreboard updates, friend feed updates, etc) is relayed from the server database to a user's device playing the “Game” and the medium which data (e.g. answers or friend information) is relayed from the user's device to the server database.

In box 2003, Question 1 downloads from the server database (box 2001) via the Internet (box 2002) and is displayed on a “Game” user's device screen.

In box 2003, a user submits an answer from their device to the corresponding Question, Question 1. That user's answer (box 2004) is relayed via the internet back to the server database as user data for Question 1 of that user's specific “Game”.

In box 2005, a question's information (Question 2) downloads from the server database (block 2001) via the Internet (block 2002) and is displayed on a “Game” user's device screen.

In box 2006, a user submits an answer from their device to the corresponding question, Question 2 (box 2005). That user's answer (Question 2 Answer, box 2006) is relayed via the internet back to the server database as user data for question 2 for that user's specific “Game”.

In box 2007, a particular question's (Question X, X defined as any question that may occur throughout the progress of a “Game”) information downloads from the server database (block 2001) via the internet (block 2002) to a “Game” user's device screen.

In box 2008, a particular answer (Question X Answer, X defined as any answer to a question that may occur throughout the progress of a “Game”) is relayed via the internet back to the server database as user data for question X for that user's specific “Game”. The game continues on with questions until the last question of that particular “Game” has been asked and answered.

FIG. 21 is an exemplary flow diagram of the Information Submission & Scoring Response Sequence 2100. In box 2101, users are playing the interactive game via a user device e.g. Mobile Telephone, Personal Computer, Tablet Computer, gaming platform or Laptop Computer.

In box 2102, during each sequence of the game, users answer questions or participate in other types of game play. The action of the user is submitted by the user as he or she plays and relayed to the server database via internet connection.

In box 2103, once the server database receives the user's performance data, the data is submitted and routed to the respective live sporting games sub-database for the interactive game which the user is playing. Once that data has been relayed to the respective games sub-database the user's performance is logged to the respective sequence of the game.

In box 2104, as users submit answers, the answers are relayed to the server database and a computing engine compiles user data and tabulates the outcome of each sequence in a respective game.

In box 2105, as the data is compiled and tabulated in the database. Points are allocated based on the performance of each team's users and the point totals for each sequence are relayed back via the internet to the user's scoreboard.

In box 2106, the performance data is relayed back to the user's device via the internet.

In box 2107, users receive data from the data base and may track their team's performance via the game application and the scoreboard of each individual game taking place on the game network which is updated in real time.

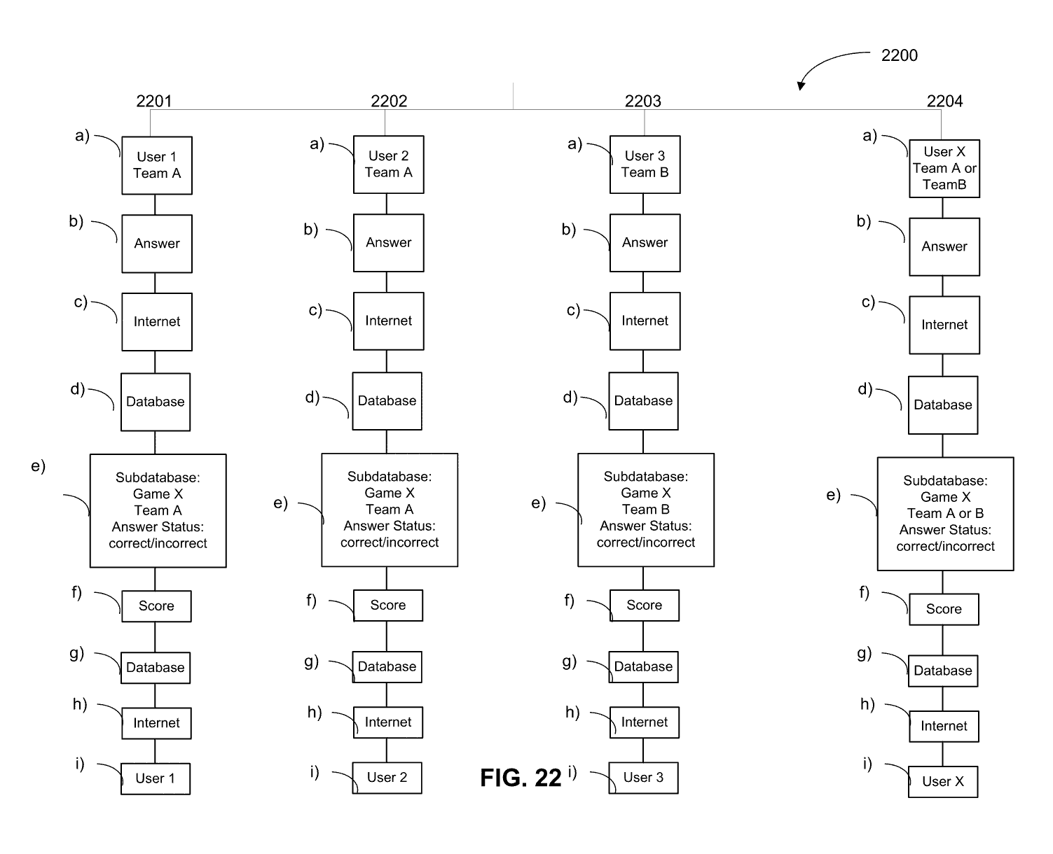

FIG. 22, User Base Scoring Process: Question X is an exemplary flow diagram 2200 showing how information is created by users and processed into the server database to develop a score for a specific “Game”. Users in this example have selected the “Game” which they would like to participate in and are answering questions downloaded to their user device from the server. This example depicts GAME XYB between Team A and Team B.

In diagram 2201 of FIG. 22:
block 2201a) User 1 Team A—The user defined by his/her identification code (USER1) and the team (Team A) he/she is playing for in GAME XYB
block 2201b) User 1 Team A's answer—The user has submitted his/her answer for “Question X”
block 2201c) Internet—The users answer for “Question X” is relayed from the user device via the internet to the server database.
block 2201d) Database—The server database collects the information which users submit for “Question X”
block 2201e) Sub Database—The collected data is routed to GameXYB's Sub-database. In that Sub-database a user's performance is logged based on the team for which they are playing (in this example User 1's performance for Team A). That users performance is added to his/her teams answer pool and used to determine the scoring for Team A for “Question X”.
block 2201f) Score—As users submit answers a score begins to tabulate between Team A & Team B.
block 2201g) Database—That information is stored in the database and is relayed to the users device via the internet
block 2201h) Internet—The games scoring information data relays back to the User's device via the internet
block 2201i) USER 1—The score is relayed back to the user's device via the internet and displayed in the “Game”

In diagram 2202 of FIG. 22:
block 2202a) User 2 Team A—The user is defined by his/her identification code (USER2) and the team (Team A) he/she is playing for in GAME XYB
block 2202b) User 2 Team A's answer—The user has submitted his/her answer for “Question X”
block 2202c) Internet—The user's answer for “Question X” is relayed from the user device via the internet to the server database
block 2202d) Database—The server database collects the information which users submit for “Question X”
block 2202e) Sub Database—The collected data is routed to GameXYB's sub-database. In that sub-database a user's performance is logged based on the team for which they are playing (in this example User 2's performance for Team A). That user's performance is added to his/her teams answer pool and used to determine the scoring for Team A for “Question X”.
block 2202f) Score—As users submit answers a score begins to tabulate between Team A & Team B.
block 2202g) Database—That information is stored in the server database and is relayed to the users device via the internet
block 2202h) Internet—The games scoring information data relays back to the Users device via the internet,
block 2202i) USER 2—The score is relayed back to the user's device via the internet and displayed in the “Game”

In diagram 2203 of FIG. 22:
block 2203a) The user defined by his/her identification code (USER31) and the team (Team B) he/she is playing for in GAME XYB
block 2203b) User 31 Team B's answer—The user has submitted his/her answer for “Question X”
block 2203c) Internet—The users answer for “Question X” is relayed from the user device via the internet to the server database
block 2203d) Database—The server database collects the information which users submit for Question X
block 2203e) Sub Database—The collected data is routed to GameXYB's Sub-database. In that sub-database a user's performance is logged based on the team for which they are playing (in this example User31's performance for Team B). That users performance is added to his/her teams answer pool and used to determine the scoring for Team B “Question X”.
block 2203f) Score—As users submit answers a score begins to tabulate between Team A & Team B.
block 2203g) Database—That information is stored in the server database and is relayed to the user's device via the internet
block 2203h) Internet—The games scoring information data relays back to the User's device via the internet
block 2203i) USER 31—The score is relayed back to the user's device via the internet and displayed in the “Game”

In diagram 2204 of FIG. 22:
block 2204a) User X Team A or Team B—This user noted as (USERX, X denoting any additional users playing the “Game XYB”)2, and his/her team choice, either Team A or Team B in GAME XYB.
block 2204b) User X Team A or B's answer—The user has submitted his/her answer for “Question X”.
block 2204c) Internet—The users answer for “Question X” is relayed via the internet to the server database.
block 2204d) Database—The server database collects the information which users submit for Question 1.
block 2204e) Sub Database—The collected data is routed to GameXYB's sub-database. In that sub-database a user's performance is logged based on the team for which they are playing (in this example User X's performance would be logged to either Team A or Team B's answer pool depending on which team the Xth user is playing for). User X's answer is added to his/her teams answer pool and used to determine the scoring for User X's Team for “Question X”.
block 2204f) Score—As users submit answers a score begins to tabulate between Teams A & B.
block 2204g) Database—That information is stored in the server database and is relayed to the user's device via the internet
block 2204h) Internet—The games scoring information data relays back to the user's device via the internet
block 2204i) USER X— The score is relayed back to the user's device via the internet and displayed in the “Game”

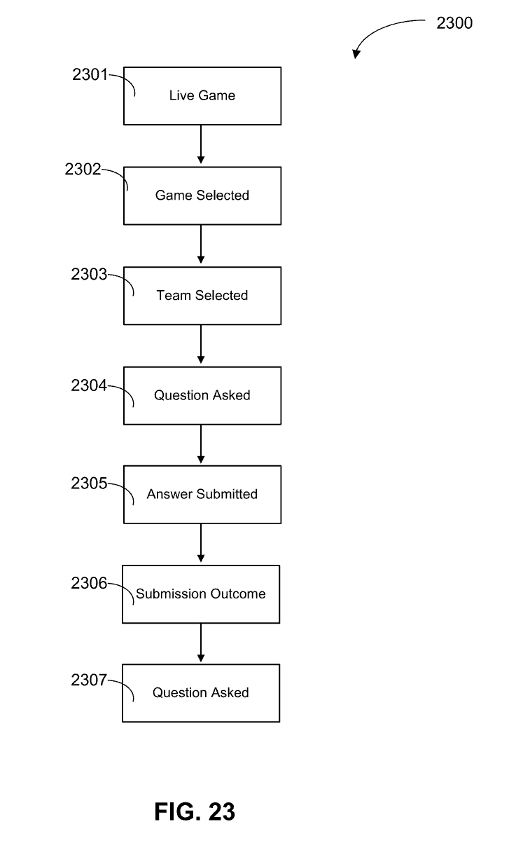

FIG. 23 is a flow chart of an exemplary Question Tether Diagram. In box 2301 of FIG. 23, a live professional or college sporting event is taking place e.g. NFL, NBA, MLB, NHL, PGA, Tennis, NASCAR, NCAA Football, NCAA basketball. Each of the games taking place is listed on the “Game's” gaming interface.

In box 2302 of FIG. 23, a user engages the “Game's” application and he/she selects which of the live sporting events he/she would like to participate in. Once that has been selected the user's performance will be logged to that respective team's database.

In box 2303 of FIG. 23, once the game is selected and the user selects which team he/she would like to represent then the game play will begin. The user's performance through the progress of the game will be logged to that respective team's database.

In box 2304 of FIG. 23, questions (or other forms of game play) are downloaded from the server data base and displayed on the “Main Game Screen” which the user can engage in game play from.

In box 2305 of FIG. 23, once an answer has been submitted by a user, his/her answer is relayed via the internet to the server database.

In box 2306 of FIG. 23, a user is then told whether his/her question was answered correctly.

In box 2307 of FIG. 23, once a user has submitted an answer the next question is downloaded from the server database and the user begins the answering process again (back to box 4). It should be noted that questions may be streamed to a user's device such that subsequent questions may be downloaded before the user has finished answering the current question. In other words, the user need not wait for the next question to be downloaded before beginning the answering process.

### Score Multiplier

In another embodiment of the invention, the professional team's performance during the live game would affect the interactive game of the fan team in some manner. In one embodiment, a point multiplier or bonus points may be awarded to the final score of Fan Squad of the winning professional team. For example, if Team A's professional team wins the game, Team A's final score may be augmented by a predetermined amount of bonus points or a point multiplier may be applied to Team A's final score.

In a similar embodiment, a point multiplier or bonus points may be applied to the points awarded to the winning team of the interactive game if their professional team wins as well. Thus, in this embodiment, the scoring of the interactive game is not affected by the professional game, but the amount of points rewarded to the winning team may be greater if their professional team wins as well.

### Momentum Meter

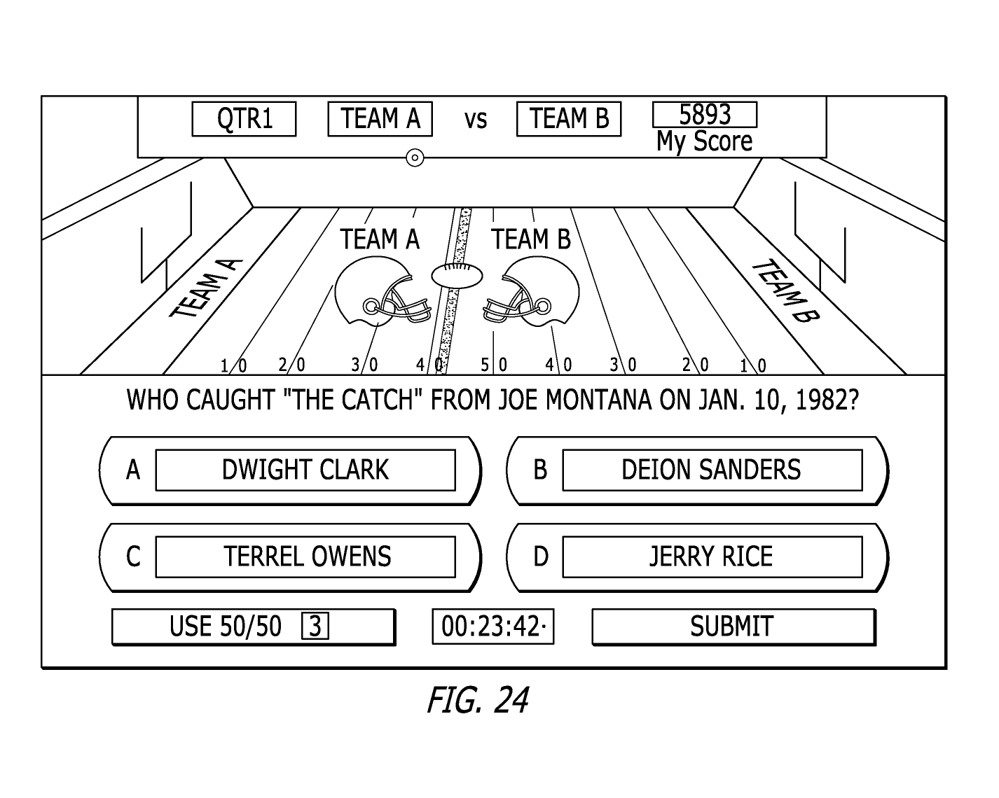

The momentum meter 2400 is another embodiment of the invention for visually depicting the score during a gaming session. The first team's score and the second team's score object are visually depicted as movement towards a goal instead of just as a number. Instead of having the score board displayed only as a numerical value, an actual field design is incorporated into the game. The position of the participating team's helmet moves along the field based on the strength of a team's performance throughout a quarter. For example, as illustrated in FIG. 24, if the 49ers® are playing the Giants® and the 49ers® helmet is on the Giant's® 20 yard line, this would indicate that the 49ers® are winning that quarter by a large margin.

This feature accommodates the addition of players coming into play at different times during a quarter. Addition of players at various random times may cause difficulty in determining a concrete score during game play. In embodiments of the invention incorporating a momentum meter, numerical scores may be displayed once the quarter is actually finished. Thus the momentum indicator may replace the scoreboard during the quarter. The scoreboard is still in play once the quarter is over, and an accurate calculation of the score may be displayed.

While the invention has been described in connection with various embodiments, it will be understood that the invention is capable of further modification. The above exemplary embodiments reference Team A and Team B as examples of competing teams that a user may join during competition. It should be understood however, that the invention is not limited to only two teams. For example in multi-player competitions such as golf or NASCAR, users may join the fan squad of their favorite player/driver in a tournament and compete against a plurality of other fan squad.

The invention is also not limited to just sporting events. The principles and inventive concept may be applied to competitive events such as Academy Awards and Political Elections. Fans of a particular star or supporters of a candidate may compete against fans and supporters of other stars and candidates.

This application is intended to cover any variations, uses or adaptation of the invention following, in general, the principles of the invention, and including such departures from the present disclosure as come within the known and customary practice within the art to which the invention pertains.

What is claimed is:

1. A system for an interactive competition, comprising:
a network interface coupled to a network; and
a processor adapted to:
instantiate an interactive competition object comprising:
a competition rule object configured to apply rules of the interactive competition;
a time-of-play object configured to indicate a beginning and an end of the interactive competition based on a time in which a live competition is being performed:
a first team object comprising a first set of team member objects and a first team score object; and
a second team object comprising a second set of team member objects and a second team score object; and
transmit an interactive competition interface in accordance with the competition rule object to a plurality of team member devices coupled to the network by way of the network interface;
receive information from the plurality of team member devices by way of the interactive competition interface, the network and the network interface; and
update the first team score object and the second team score object based on the information received from the team member devices and rules received from the competition rule object.

2. The system of claim 1, wherein the first team object is related to a first team of the live competition, and the second team object is related to a second team of the live competition.

3. The system of claim 1, wherein the processor is further adapted to provide information related to the interactive competition to the plurality of team member devices by way of the network interface, network and interactive competition interface.

4. The system of claim 2, wherein the first team and second team correspond to professional or collegiate sport teams.

5. The system of claim 2, wherein the first team and second team correspond to celebrities.

6. The system of claim 2, wherein the first team and second team correspond to political candidates.

7. A method for an interactive competition, comprising:
creating an interactive competition object comprising:
a competition rule object configured to apply rules of the interactive competition;
a time-of-play object configured to indicate a beginning and an end of the interactive competition based on a time in which a live competition is being performed:
a first team object comprising a first set of team member objects and a first team score object; and
a second team object comprising a second set of team member objects and a second team score object; and
transmitting an interactive competition interface in accordance with the competition rule object to a plurality of team member devices coupled to the network by way of the network interface;
receiving information from the plurality of team member devices by way of the interactive competition interface, the network and the network interface; and
updating the first team score object and the second team score object based on the information received from the team member devices and rules received from the competition rule object.

8. The method of claim 7, wherein the first team object is related to a first team of the live competition, and the second team object is related to a second team of the live competition.

9. The method of claim 7, further comprising:
providing information related to the interactive competition to the plurality of team member devices by way of the network interface, network and interactive competition interface.

10. The method of claim 8, wherein the first team and second team are professional or collegiate sport teams.

11. The method of claim 8, wherein the first team and second team are celebrities.

12. The method of claim 8, wherein the first team and second team are political candidates.
